(19) United States
(12) Patent Application Publication
(10) Pub. No.: US 2016/0078844 A1
(43) Pub. Date: Mar. 17, 2016

(54) ELECTRONIC DEVICE AND METHOD FOR CONTROLLING DISPLAY DEVICE OF THE ELECTRONIC DEVICE

(71) Applicant: CHIUN MAI COMMUNICATION SYSTEMS, INC., New Taipei (TW)

(72) Inventors: HOW-WEN CHIEN, New Taipei (TW); PEI-TI LEE, New Taipei (TW)

(21) Appl. No.: 14/832,560

(22) Filed: Aug. 21, 2015

(30) Foreign Application Priority Data
Sep. 16, 2014 (CN) 201410473022.X

(51) Int. Cl. G09G 5/10; G06F 3/00; G06F 3/01

(52) U.S. Cl. CPC G09G 5/10; G06F 3/017; G06F 3/005; G09G 2354/00; G09G 2360/144; G09G 2320/0626

(57) ABSTRACT

Method of controlling a display device of an electronic device includes activating a camera lens of the electronic device. The camera lens is controlled to capture images at predetermined time intervals. The display device is controlled according to the captured images.

### CROSS-REFERENCE TO RELATED APPLICATIONS

This application claims priority to Chinese Patent Application No. 201410473022.X filed on Sep. 16, 2014, the contents of which are incorporated by reference herein.

### FIELD

The subject matter herein generally relates to electronic device managing technology, and particularly to an electronic device and a method for controlling a display device of the electronic device.

### BACKGROUND

Generally, brightness of a display device of an electronic device can be automatically adjusted, according to ambient light of the electronic device that is detected by a light sensor configured in the electronic device. However, the configuration of the light sensor creates a complicated circuit design, and leads to extra cost for a manufacturer to produce the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device.

FIG. 2 is a block diagram of function modules of a control system.

FIG. 3 illustrates a flowchart of one embodiment of a first method for controlling a display device.

FIG. 4 illustrates a flowchart of one embodiment of a second method for controlling a display device.

FIG. 5 illustrates a flowchart of one embodiment of a third method for controlling a display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

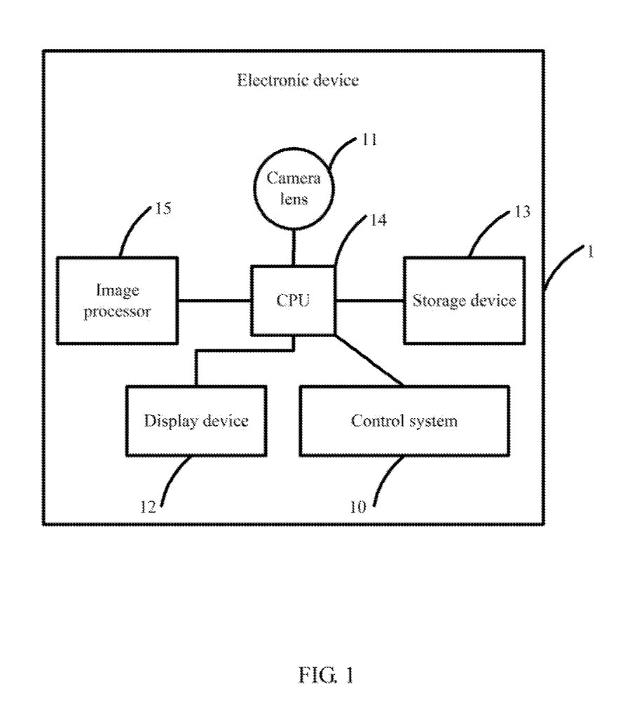

FIG. 1 is a block diagram of one embodiment of an electronic device. In at least one embodiment, an electronic device 1 includes a control system 10, a camera lens 11, a display device 12, a storage device 13, at least one central processor unit (CPU) 14, and at least one image processor 15. Depending on the embodiment, the electronic device 1 may be a smart phone, a personal digital assistant (PDA), a tablet computer, or any other suitable electronic device. FIG. 1 illustrates only one example of the electronic device 1 that may include more or fewer components than illustrated, or have a different configuration of the various components in other embodiments.

The camera lens 11 can be used to capture images. The camera lens 11 can be a digital zoom lens or other suitable lens such as an optical zoom lens. In one embodiment, the camera lens 11 can be internally configured in the electronic device 1. In another embodiment, the camera lens 11 can be externally configured in the electronic device 1. In one embodiment, the camera lens 11 is installed in the front side of the electronic device 1. In another embodiment, the camera lens is installed in a back side of the electronic device 1.

The display device 12 can display information such as images. The display device 12 can display the information of the electronic device 1 in a landscape mode or in a portrait mode. In one embodiment, the display device 12 can be a super twisted nematic (STN) screen, a thin film transistor (TFT) screen, a thin film diode (TFD) screen, an ultra fine & bright (UFB) screen, an organic light emitting display (OLED) screen, or a advanced super view (ASV) screen.

In one embodiment, the storage device 13 can be an internal storage device, such as a flash memory, a random access memory (RAM) for temporary storage of information, and/or a read-only memory (ROM) for permanent storage of information. The storage device 13 can also be an external storage device, such as an external hard disk, a storage card, or a data storage medium.

The control system 10 can control operations of the display device 12 according to the images captured by the camera lens 11. In one embodiment, the operations include, but are not limited to, adjusting brightness of the display device 12, switching images displayed on the display device 12, switching web pages displayed on the display device 12.

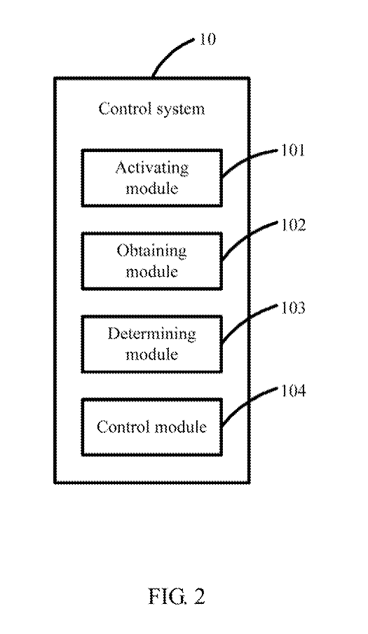

FIG. 2 is a block diagram of function modules of a control system. In at least one embodiment, a control system 10 may include an activating module 101, an obtaining module 102, a determining module 103, and a control module 104. The function modules 101-104 may include computerized codes in the form of one or more programs, which are stored in the storage device 13, and are executed by the at least one CPU 14 to control the display device 12. Details will be given in the following paragraphs according to three examples.

In a first example of controlling the display device 12, the activating module 101 can unlock the electronic device 1 when an unlocking signal is received. The unlocking signal can be generated by a sliding touch on the display device 12. For example, the activating module 101 can unlock the electronic device 1 when the sliding touch matches a predetermined sliding path.

The activating module 101 can activate the camera lens 11 when the electronic device 1 is unlocked.

The obtaining module 102 can control the camera lens 11 to capture an image of an ambience surrounding the electronic device 1 at predetermined time intervals. For example, the obtaining module 102 can control the camera lens 11 to capture the image of the ambience surrounding the electronic device 1 once every two seconds.

The obtaining module 102 can further identify a brightness value of the image of the ambience surrounding the electronic device 1.

In one embodiment, the obtaining module 102 converts a RGB (Red, Green, Blue) color mode of the image of the ambience surrounding the electronic device 1 to be a HSL (Hue, Saturation, Lightness) color mode, and then obtains the brightness value of the image of the ambience surrounding the electronic device 1 by extracting the Lightness value from the HSL color mode.

For example, the brightness value of an image may be an average of the brightness values of all or a part of the pixels of the image.

The determining module 103 can compare the brightness values of two continuously captured images.

When the brightness value of a current captured image is greater than the brightness value of a previously captured image, the control module 104 can turn up the brightness of the display device 12. When the brightness value of the current captured image is less than the brightness value of the previously captured image, the control module 104 can turn down the brightness of the display device 12.

In a second example of controlling the display device 12, the activating module 101 can activate the camera lens 11 when a predetermined application is running in the electronic device 1. The predetermined application may be an image viewer, a web browser, for example.

The obtaining module 102 can control the camera lens 11 to capture an image of a hand of a user at predetermined time intervals. For example, the obtaining module 102 can control the camera lens 11 to capture the image of the hand of the user every 2 seconds. The obtaining module 102 can further store the image of the hand of the user in the storage device 13.

The determining module 103 can identify a position difference of the hand of the user in two continuously captured images. The control module 104 can control the display device 12 to adjust content displayed on the display device 12 according to the position difference. The content may be an image, a webpage, for example.

In one embodiment, when a position of the hand of the user in a current captured image is higher than a position of the hand of the user in a previously captured image, the control module 104 can control the display device 12 to enlarge the content currently displayed on the display device 12 by a predetermined ratio, such as 10 percent. When the position of the hand of the user in the current captured image is lower than the position of the hand of the user in the previously captured image, the control module 104 can control the display device 12 to reduce the content currently displayed on the display device 12 by a predetermined ratio, such as 15 percent.

When the position of the hand of the user in the current captured image is on the left of the position of the hand of the user in the previously captured image, the control module 104 can control the display device 12 to switch to a previous content. When the position of the hand of the user in the current captured image is on the right of the position of the hand of the user in the previously captured image, the control module 104 can control the display device 12 to display next content.

In general, the control system 10 can predefine a plurality of position differences of the hand of the user in two continuously captured images. The control system 10 can further predefine a plurality of adjustments on the content displayed on the display device 12. Each predefined position difference of the hand of the user in two continuously captured images is corresponding to a predefined adjustment on the content displayed on the display device 12. The determining module 103 can compare the position difference of the hand of the user between the current captured image and the previously captured image with the predefined position differences. When the determining module 103 determines that the position difference of the hand of the user matches one of the predefined position differences, the control module 104 can perform the corresponding predefined adjustment on the content displayed on the display device 12.

In a third example of controlling the display device 12, the obtaining module 102 can obtain a brightness value of the display device 12 when the display device 12 is activated. For example, the obtaining module 102 obtains the brightness value of the display device 12 when the electronic device is communicating with a remote electronic device. The obtaining module 102 can further store the brightness value of the display device 12 in the storage device 13.

The activating module 101 can activate the camera lens 11 when the electronic device is communicating with the remote electronic device.

The obtaining module 102 can control the camera lens 11 to capture an image of an ambience surrounding the electronic device 1 at predetermined time intervals. For example, the obtaining module 102 can control the camera lens 11 to capture the image of the ambience surrounding the electronic device 1 every 2 seconds.

The obtaining module 102 can further identify a brightness value of the image of the ambience surrounding the electronic device 1. In one embodiment, the obtaining module 102 first converts a RGB (Red, Green, Blue) color mode of the image of the ambience surrounding the electronic device 1 to be a HSL (Hue, Saturation, Lightness) color mode, and then obtains the brightness value of the image of the ambience surrounding the electronic device 1 by extracting the Lightness value from the HSL color mode.

The determining module 103 can identify whether the brightness value of a current captured image is less than the brightness value of the display device 12 stored in the storage device 13.

When the brightness value of the current captured image is less than the brightness value of the display device 12 stored in the storage device 13, the control module 104 can turn down the brightness of the display device 12 to save power. For example, the control module 104 can turn off the display device 12.

When the brightness value of the current captured image is not less than the brightness value of the display device 12 stored in the storage device 13, the control module 104 can keep the brightness of the display device 12.

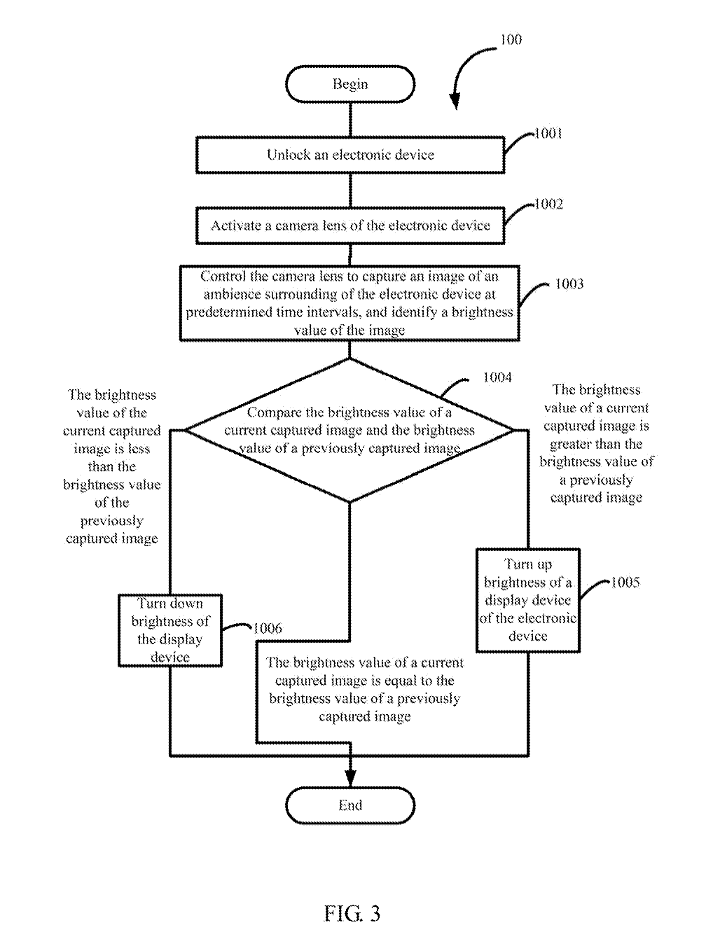

FIG. 3 illustrates a flowchart of one embodiment of a first method for controlling a display device of an electronic device. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 3 represents one or more processes, methods or subroutines, carried out in the exemplary method 100. Furthermore, the illustrated order of blocks is by example only and the order of the blocks can be changed according to the present disclosure. The exemplary method 100 can begin at block 1001. Depending on the embodiment, additional steps can be added, others removed, and the ordering of the steps can be changed.

At block 1001, an activating module can unlock an electronic device when an unlocking signal is received. The unlocking signal can be generated by a sliding touch on a display device of an electronic device. For example, the activating module can unlock the electronic device when the sliding touch matches a predetermined sliding path.

At block 1002, the activating module can activate a camera lens of the electronic device when the electronic device is unlocked.

At block 1003, an obtaining module can control the camera lens to capture an image of an ambience surrounding the electronic device at predetermined time intervals. For example, the obtaining module can control the camera lens to capture the image of the ambience surrounding the electronic device every 2 seconds.

The obtaining module can further identify a brightness value of the image of the ambience surrounding the electronic device.

In one embodiment, the obtaining module converts a RGB (Red, Green, Blue) color mode of the image of the ambience surrounding the electronic device to be a HSL (Hue, Saturation, Lightness) color mode, and then obtains the brightness value of the image of the ambience surrounding the electronic device by extracting the Lightness value from the HSL color mode.

For example, the brightness value of an image may be an average of the brightness values of all or a part of the pixels of the image.

At block 1004, a determining module can compare the brightness values of two continuously captured images.

When the brightness value of a current captured image is greater than the brightness value of a previously captured image, the process goes to block 1005. When the brightness value of the current captured image is less than the brightness value of the previously captured image, the process goes to block 1006. When the brightness value of the current captured image is equal to the brightness value of the previously captured image, the process ends.

At block 1005, a control module can turn up the brightness of a display device of the electronic device.

At block 1006, the control module can turn down the brightness of the display device.

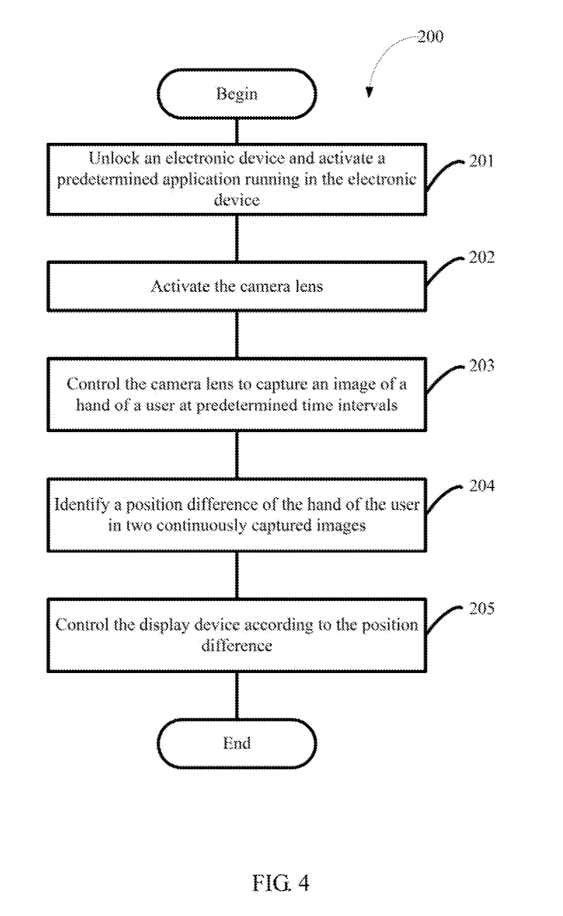

FIG. 4 illustrates a flowchart of one embodiment of a second method for controlling a display device of an electronic device. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 4 represents one or more processes, methods or subroutines, carried out in the exemplary method 200. Furthermore, the illustrated order of blocks is by example only and the order of the blocks can be changed according to the present disclosure. The exemplary method 200 can begin at block 201. Depending on the embodiment, additional steps can be added, others removed, and the ordering of the steps can be changed.

At block 201, an activating module can unlock an electronic device and activate a predetermined application running in the electronic device. The predetermined application may be an image viewer, a web browser, for example.

At block 202, the activating module can activate a camera lens of the electronic device when the predetermined application is running in the electronic device. For example, the activating module can activate the camera lens when the image viewer displays an image on a display device of the electronic device.

At block 203, an obtaining module can control the camera lens to capture an image of a hand of a user at predetermined time intervals. For example, the obtaining module can control the camera lens to capture the image of the hand of the user every 2 seconds. The obtaining module can further store the image of the hand of the user in a storage device of the electronic device.

At block 204, an determining module can identify a position difference of the hand of the user in two continuously captured images.

At block 205, a control module can control the display device to adjust content displayed on the display device according to the position difference. The content may be an image, a webpage, for example.

In one embodiment, when a position of the hand of the user in a current captured image is higher than a position of the hand of the user in a previously captured image, the control module can control the display device to enlarge the content currently displayed on the display device by a predetermined ratio, such as 10 percent. When the position of the hand of the user in the current captured image is lower than the position of the hand of the user in the previously captured image, the control module can control the display device to reduce the content currently displayed on the display device by a predetermined ratio, such as 15 percent.

When the position of the hand of the user in the current captured image is on the left of the position of the hand of the user in the previously captured image, the control module can control the display device to switch to a previous content. When the position of the hand of the user in the current captured image is on the right of the position of the hand of the user in the previously captured image, the control module can control the display device to display a next content.

In general, the control module can predefine a plurality of position differences of the hand of the user in two continuously captured images. The control module can further predefine a plurality of adjustments on the content displayed on the display device. Each predefined position difference of the hand of the user in two continuously captured images is corresponding to a predefined adjustment on the content displayed on the display device. The determining module can compare the position difference of the hand of the user between the current captured image and the previously captured image with the predefined position differences. When the determining module determines that the position difference of the hand of the user matches one of the predefined position differences, the control module can perform the corresponding predefined adjustment on the content displayed on the display device.

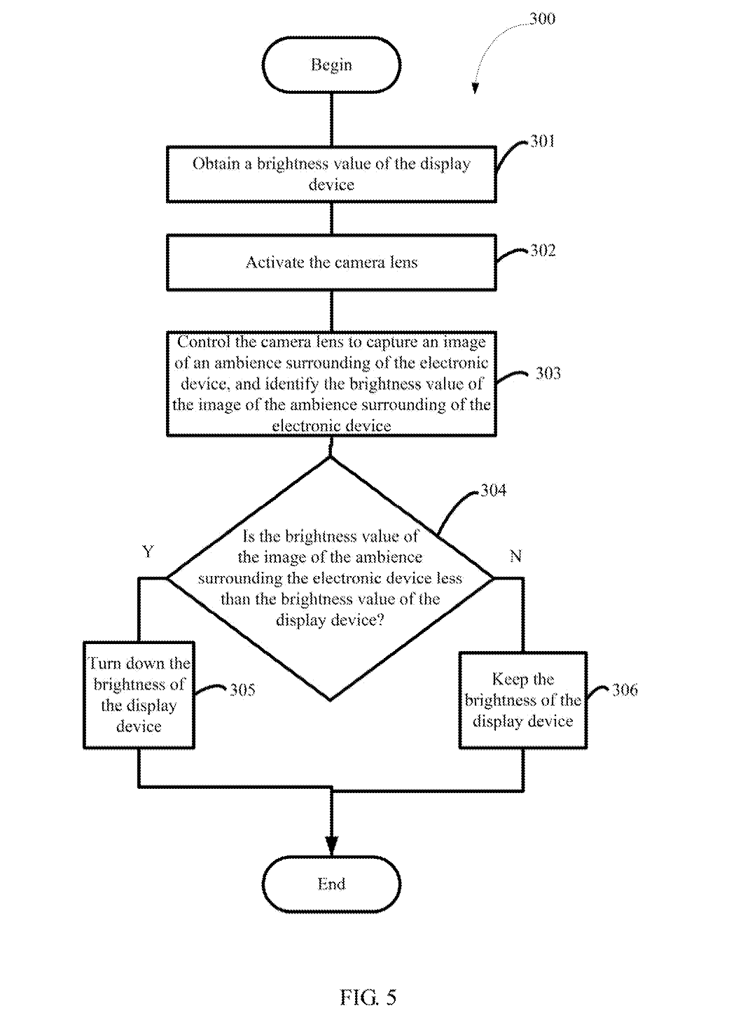

FIG. 5 illustrates a flowchart of one embodiment of a third method for controlling a display device of an electronic device. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 5 represents one or more processes, methods or subroutines, carried out in the exemplary method 300. Furthermore, the illustrated order of blocks is by example only and the order of the blocks can be changed according to the present disclosure. The exemplary method 300 can begin at block 301. Depending on the embodiment, additional steps can be added, others removed, and the ordering of the steps can be changed.

At block 301, an obtaining module can obtain a brightness value of a display device of an electronic device when the display device is activated. For example, the obtaining module obtains the brightness value of the display device when the electronic device is communicating with a remote electronic device. The obtaining module can further store the brightness value of the display device in a storage device of the electronic device.

At block 302, the activating module can activate a camera lens of the electronic device. In one embodiment, the activating module can activate the camera lens when the electronic device is communicating with the remote electronic device.

At block 303, an obtaining module can control the camera lens to capture an image of an ambience surrounding the electronic device at predetermined time intervals. For example, the obtaining module can control the camera lens to capture the image of the ambience surrounding the electronic device every 2 seconds.

The obtaining module can further identify a brightness value of the image of the ambience surrounding the electronic device. In one embodiment, the obtaining module first converts a RGB (Red, Green, Blue) color mode of the image of the ambience surrounding the electronic device to be a HSL (Hue, Saturation, Lightness) color mode, and then obtains the brightness value of the image of the ambience surrounding the electronic device by extracting the Lightness value from the HSL color mode.

At block 304, a determining module can identify whether the brightness value of a current captured image is less than the brightness value of the display device stored in the storage device.

When the brightness value of the current captured image is less than the brightness value of the display device stored in the storage device, the process goes to block 305. When the brightness value of the current captured image is not less than the brightness value of the display device stored in the storage device, the process goes to block 306.

At block 305, the control module can turn down the brightness of the display device to save power. For example, the control module can turn off the display device.

At block 306, the control module can keep the brightness of the display device.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for controlling a display device of an electronic device, the method comprising:
activating a camera lens of the electronic device;
controlling the camera lens to capture images at predetermined time intervals;
controlling the display device according to the captured images.

2. The method according to claim 1, wherein the images captured at the predetermined time intervals are images of an ambience surrounding of the electronic device.

3. The method according to claim 2, wherein the step of controlling the display device comprise:
identifying difference between two continuously captured images;
turning up brightness of the display device when a brightness value of a current captured image is greater than a brightness value of a previously captured image; and
turning down the brightness of the display device when the brightness value of the current captured image is less than the brightness value of the previously captured image.

4. The method according to claim 2, wherein the step of controlling the display device comprise:
turning down brightness of the display device when a brightness value of a current captured image is less than a brightness value of the display device; and
keeping the brightness of the display device when the brightness value of the current captured image is not less than the brightness value of the display device.

5. The method according to claim 1, wherein the image captured at each of the predetermined time intervals is an image of a hand of a user of the electronic device.

6. The method according to claim 5, wherein the step of controlling the display device comprise:
predefining a plurality of first position differences of the hand of the user in two continuously captured images;
predefining a plurality of adjustments on content displayed on the display device, wherein each of the first position differences is corresponding to one of the predefined adjustments;
comparing a second position difference of the hand of the user between a current captured image and a previously captured image with the first position differences; and
performing the predefined adjustment corresponding to the first position difference matching the second position difference on the content displayed on the display device.

7. An electronic device, comprising:
a display device;
at least one processor; and
a storage device that stores one or more programs, when executed by the at least one processor, cause the at least one processor to:
activate a camera lens of the electronic device;
control the camera lens to capture images at predetermined time intervals;
control the display device according to the captured images.

8. The electronic device according to claim 7, wherein the images captured at the predetermined time intervals are images of an ambience surrounding of the electronic device.

9. The electronic device according to claim 8, wherein the step of controlling the display device comprise:
identifying difference between two continuously captured images;
turning up brightness of the display device when a brightness value of a current captured image is greater than a brightness value of a previously captured image; and
turning down the brightness of the display device when the brightness value of the current captured image is less than the brightness value of the previously captured image.

10. The electronic device according to claim 8, wherein the step of controlling the display device comprise:
turning down brightness of the display device when a brightness value of a current captured image is less than a brightness value of the display device; and
keeping the brightness of the display device when the brightness value of the current captured image is not less than the brightness value of the display device.

11. The electronic device according to claim 7, wherein the image captured at each of the predetermined time intervals is an image of a hand of a user of the electronic device.

12. The electronic device according to claim 11, wherein the step of controlling the display device comprise:
predefining a plurality of first position differences of the hand of the user in two continuously captured images;
predefining a plurality of adjustments on content displayed on the display device, wherein each of the first position differences is corresponding to one of the predefined adjustments;
comparing a second position difference of the hand of the user between a current captured image and a previously captured image with the first position differences; and
performing the predefined adjustment corresponding to the first position difference matching the second position difference on the content displayed on the display device.

13. A non-transitory storage medium having stored thereon instructions that, when executed by a processor of an electronic device, causes the processor to perform a method for controlling a display device of the electronic device, wherein the method comprises:
activating a camera lens of the electronic device;
controlling the camera lens to capture images at predetermined time intervals;
controlling the display device according to the captured images.

14. The non-transitory storage medium according to claim 13, wherein the images captured at the predetermined time intervals are images of an ambience surrounding of the electronic device.

15. The non-transitory storage medium according to claim 14, wherein the step of controlling the display device comprise:
identifying difference between two continuously captured images;
turning up brightness of the display device when a brightness value of a current captured image is greater than a brightness value of a previously captured image; and
turning down the brightness of the display device when the brightness value of the current captured image is less than the brightness value of the previously captured image.

16. The non-transitory storage medium according to claim 14, wherein the step of controlling the display device comprise:
turning down brightness of the display device when a brightness value of a current captured image is less than a brightness value of the display device; and
keeping the brightness of the display device when the brightness value of the current captured image is not less than the brightness value of the display device.

17. The non-transitory storage medium according to claim 13, wherein the image captured at each of the predetermined time intervals is an image of a hand of a user of the electronic device.

18. The non-transitory storage medium according to claim 17, wherein the step of controlling the display device comprise:
predefining a plurality of first position differences of the hand of the user in two continuously captured images;
predefining a plurality of adjustments on content displayed on the display device, wherein each of the first position differences is corresponding to one of the predefined adjustments;
comparing a second position difference of the hand of the user between a current captured image and a previously captured image with the first position differences; and
performing the predefined adjustment corresponding to the first position difference matching the second position difference on the content displayed on the display device.
